(19) United States
(12) Patent Application Publication
(10) Pub. No.: US 2026/0032798 A1
(43) Pub. Date: Jan. 29, 2026

(54) PORTABLE LIGHTING APPARATUS FOR WEATHER NOTIFICATIONS

(71) Applicant: Weatherstem, Inc., Tallahassee, FL (US)

(72) Inventor: Edward Bryan Mansouri, Tallahassee, FL (US)

(21) Appl. No.: 19/280,320

(22) Filed: Jul. 25, 2025

Related U.S. Application Data
(60) Provisional application No. 63/676,088, filed on Jul. 26, 2024.

(51) Int. Cl. H05B 47/19; F21L 4/00; F21V 23/04; F21Y 113/17; G08B 3/10; G08B 5/36; G08B 7/06; G08B 21/18; H05B 47/155; H05B 47/16

(52) U.S. Cl. CPC H05B 47/19; F21L 4/00; F21V 23/0435; G08B 3/10; G08B 5/36; G08B 7/06; G08B 21/18; H05B 47/155; H05B 47/16; F21Y 2113/17

(57) ABSTRACT

Disclosed are various embodiment for portable lighting apparatus that provides notifications for local weather conditions. In one example, a portable lighting apparatus includes a lighting device, a controller device, and a rod member. The lighting device and the controller device are attached to the rod member. The controller device is configured to identify a location of the portable lighting apparatus and receive a present weather condition for the location from a remote computing device. The present weather condition can be determined to satisfy an alert condition from a lighting data model for the location. The lighting device can be activated based at least in part on the present weather condition satisfying the alert condition.

### BACKGROUND

Weather conditions can be dynamic and difficult to predict. Nevertheless, individuals rely on weather forecasts to plan activities, particularly outdoor events and travel plans. For example, a significant chance of thunderstorms in the forecast may lead an individual to reschedule a planned outdoor activity. However, weather forecasts can be unreliable, especially when predicting conditions further into the future.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A illustrates a pictorial diagram of a lighting arrangement around a perimeter of a soccer field, according to one embodiment described herein.

FIG. 1B illustrates an exploded view of a lighting apparatus according to one embodiment described herein.

FIG. 1C illustrates another view of the lighting apparatus according to one embodiment described herein.

FIG. 2 illustrates a drawing of a network environment according to one embodiment described herein.

FIG. 3 is a flowchart illustrating one example of functionality implemented as portions of an application executed in a computing environment in the network environment of FIG. 2 according to various embodiments of the present disclosure.

FIG. 4 is a flowchart illustrating one example of functionality implemented as portions of an application executed in a computing environment in the network environment of FIG. 2 according to various embodiments of the present disclosure.

FIGS. 5A-5F illustrate example user interfaces displayed by the client device in the network environment of FIG. 2 according to various embodiments of the present disclosure.

### DETAILED DESCRIPTION

The present disclosure relates to various embodiments for a portable lighting apparatus for providing notifications or alerts for local weather conditions. Often, weather forecasts provided to the public are based least in part on one or more computer-based weather models that take in account various environment conditions. However, these weather models can have inaccuracies due to the dynamic nature of atmospheric conditions. Weather forecast inaccuracies can increase as the difference between the current time and the forecasted time period in the future increases. Nevertheless, individuals and organizations rely on weather forecasts to plan activities in advance, particularly outdoor events, travel events, and other suitable activities. However, the dynamic nature of local weather conditions can lead to sudden, unexpected severe weather developments (e.g., tornados, hurricanes, lightning events, severe heat temperatures, flash floods, etc.). Weather warnings for these unexpected weather developments can help protect lives and property.

Various embodiments of the present disclosure relate to a portable lighting apparatus for providing alerts or notifications for local weather conditions to nearby individuals. In some examples, the various embodiments can notify individuals situated outside to go indoors, leave the area, and/or take other suitable safety measures for the weather events. The portable lighting apparatus can have various lighting and audible notification settings that can be customized by a user, in which different lighting and audible notifications can represent different types of weather warnings. Some non-limiting examples of customizable lighting notifications can include different lighting colors, different lighting intensities, different pulsing/flashing rates, different group lighting arrangements and other suitable lighting notifications.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

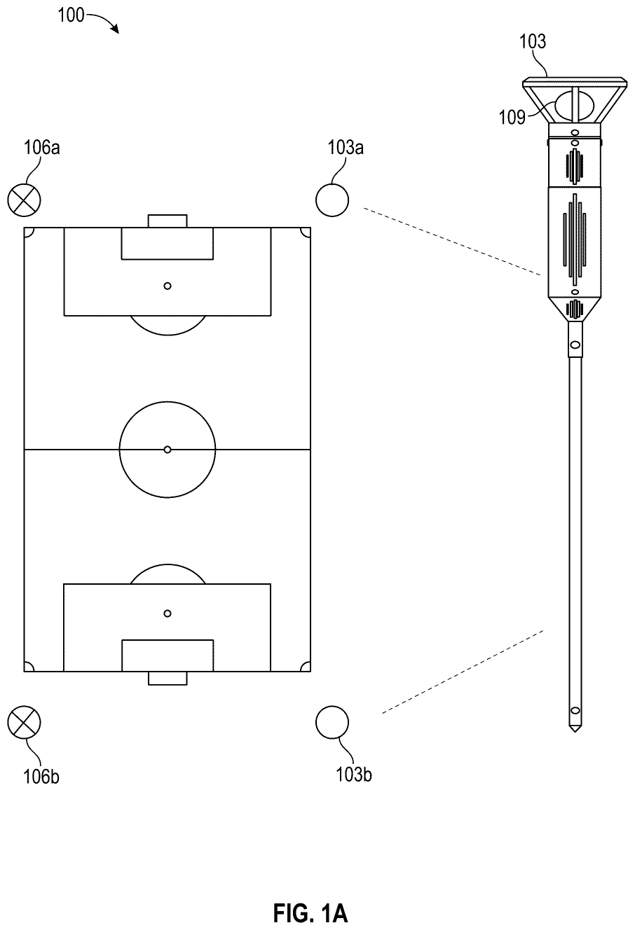

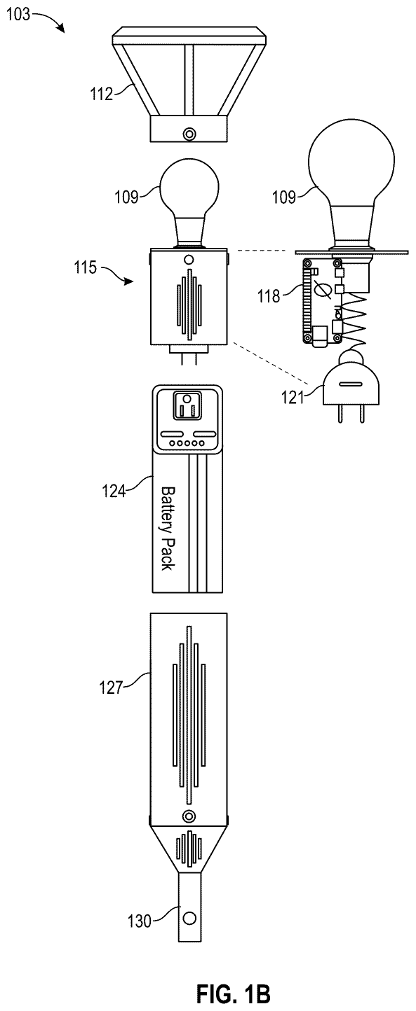

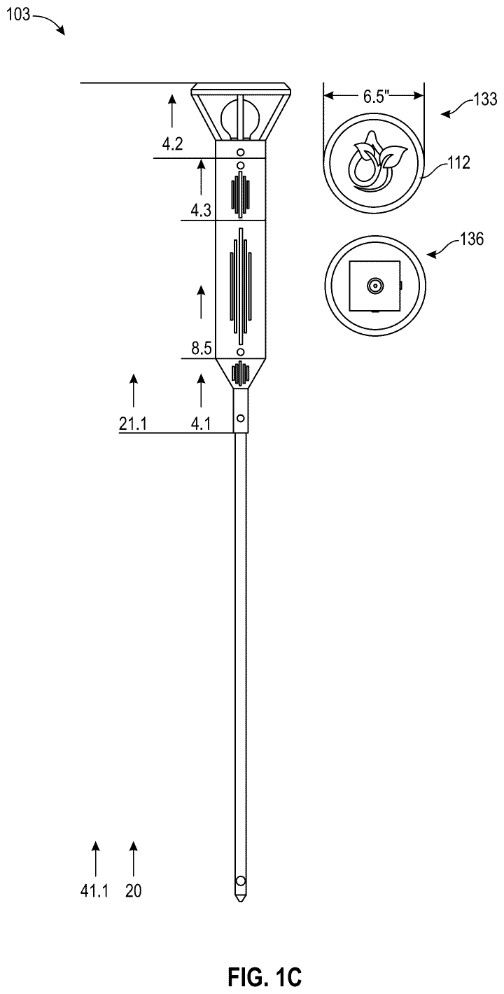

As illustrated in FIG. 1A, shown is a pictorial diagram of a use case 100 of multiple lighting devices situated around a soccer field. The lighting devices include multiple portable lighting apparatuses 103, multiple stationary light devices 106, and other suitable lighting devices.

The portable lighting apparatus 103 can represent a mobile apparatus that provides weather notifications. As shown in FIG. 1A, the portable lighting apparatus 103 has a lighting device 109 (e.g., a light bulb) for illuminating different types of weather notifications to individuals within proximity. The portable lighting apparatus 103 can be battery powered for supplying power to all its components. Since the portable lighting apparatus 103 is mobile, a user can select a location for situating the portable lighting apparatus 103. For example, the portable lighting apparatus 103 can be situated near friends and family watching the soccer game. In other examples, the portable lighting apparatus 103 can be situated near a camping site.

The portable lighting apparatus 103 can be configured by a mobile device of a user. Continuing with the example depicted in FIG. 1A, the portable lighting apparatus 103 can be in data communication with other stationary light devices 106. The portable lighting apparatus 103 can communicate lighting instructions to the stationary light devices 106. As such, the portable lighting apparatus 103 can coordinate lighting notifications for groups of lighting devices, in which different types of patterns can be configured among a group of lighting devices.

The stationary light devices 106 can represent bulb devices with communication components (e.g., WiFi, Zigbee, etc.) at a fixed location. For example, the stationary light devices 106 can represent street lights, parking lot lights, building lights, security lights, landscaping lights, and other suitable fixed lighting devices.

As a non-limiting example, a user can configure the portable lighting apparatus 103a with a set of lighting instructions. For example, the lighting devices can be situated around a soccer field in order to warn observers (e.g., friends, family members, fans, etc.), game participants, referees, and the individuals around the soccer field of severe weather conditions that are nearby. For instance, the portable lighting apparatuses 103 can be configured to all blink red upon receiving weather data indicating that a National Weather Storm alert has been issued for the local area. In another instance, the portable lighting apparatuses 103 can be configured to blink yellow upon receiving weather data for lightning strikes occurring within a predefined proximity to the location of the portable lighting apparatuses 103. For example, these lighting notifications can inform the parents, friends, and referees that the soccer game should be paused, and everyone should head indoors. These lighting notifications are centered around the location of the portable lighting apparatus 103 instead of a zip code, a city, a county or other geographical designations.

The portable lighting apparatuses 103 can transmit the same lighting instructions to the stationary light devices 106 (e.g. stationary light bulbs, light poles). As a result, in some examples, the portable lighting apparatuses 103 and the stationary light devices 106 can all illuminate the same lighting notification. As such, the portable lighting apparatuses 103 can operates a hub or a master for controlling light notifications for weather conditions.

These lighting notifications can inform nearby individuals to take shelter or leave the area in a timing manner. The lighting notifications can also inform the individuals of the type of weather warning. Additionally, the lighting notifications can be configured or user-specified for localized conditions (e.g., within a certain radius of the location of the portable lighting apparatus 103).

Moving to FIG. 1B, shown is an exploded view of the portable lighting apparatus 103. The portable lighting apparatus 103 includes a top cover 112, the lighting device 109, a controller compartment 115, a controller device 118, an electrical adapter 121, a power source 124, a component compartment 127, a rod member 130, a speaker, and other suitable components.

The top cover 112 can be attached to the controller compartment 115, and the controller compartment 115 can be attached to the component compartment 127. The component compartment 127 can be attached to the rod member 130. In some embodiments, the controller compartment 115, the component compartment 127, and the rod member 130 have a cylindrical shape.

The top cover 112 can be a structure for covering the lighting device 109. In FIG. 1B, the top cover 112 has multiple openings formed from structural members that extend from a base of the top cover 112 to a top of the top cover 112. The openings can enable the light from the lighting device 109 to be visible.

The lighting device 109 can be a device for luminating a visual light. The lighting device 109 can be configured to luminate various colors, various light intensities, flashing or pulsing light at various rates, and other suitable light characteristics. In some examples, the lighting device 109 has a communication device (e.g., a wireless transceiver) for receiving lighting instructions from the controller device 118.

The controller compartment 115 can be a structure for supporting the controller device 118, portions of the lighting device 109 and the electrical adapter 121. In some examples, controller compartment 115 has an interior cavity for housing the controller device 118, portions of the lighting device 109 and the electrical adapter 121. In other examples, the controller device 118, portions of the lighting device 109 and the electrical adapter 121 are attached in a portion of the controller compartment 115.

The controller device 118 is a computing device that can execute lighting instructions. The controller device 118 can include a controller, wireless communication devices (e.g., transceivers), sensors, antennas, location detection devices (e.g., a Global Positioning System, a beaconing device, etc.) and other suitable components. In some examples, the lighting device 109 is electrically coupled to the controller device 118.

The electrical adapter 121 can be an electrical component for conveying electrical power from the power source to one or more electrical components, such as the lighting device 109 and other suitable electrical components. In some instances, the electrical adapter 121 can convert power to a supply voltage range for the electrical components.

The power source 124 can be a component for supplying power to the electrical adapter 121, which in turn supplies power to the other electrical components. In some instances, the power source directly supplies power to some of the electrical components. For example, FIG. 1B illustrates that the controller device 118 can be electrically inserted into an electrical outlet of the power source 124. As shown in FIG. 1B, the power source 124 can be a battery that provides direct current (DC) power to the components.

In some example, the power source 124 is a battery that uses a battery management protocol for optimizing power. The battery management protocol can be executed to determine an amount of power to supply to various components. The component compartment 127 can be a structural component for supporting various components. In FIG. 1B, component compartment 127 has an interior component for housing the power source 124 (e.g., a battery).

The rod member 130 can be an elongated structure for supporting the various components of the portable lighting apparatus 103. The rod member 130 can include a first end and a second end. One of the ends can be a pointed end for being driven into the ground in order to fix the portable lighting apparatus 103. The speaker can be configured to generate an audible alert for nearby individuals. The speaker can be activated to generate the audible alert based at least in part on the alert conditions, location conditions, and other suitable conditions. In some examples, the speaker can be electrically coupled to the controller device 118. In other examples, the speaker can be battery powered and can be in data communication with the controller device 118, in which the speaker has a speaker transceiver for communicating with the transceiver of the controller device 118.

Next, FIG. 1C illustrates a side view of the portable lighting apparatus 103 in an assembled state. FIG. 1C illustrates various dimensions of the various components of the portable lighting apparatus 103. The dimension illustrated in the FIG. 1C are in inches, and it should be noted that the dimensions can vary.

Reference 133 refers to a top view of the top cover 112. In the illustrated example, the top cover 112 can include an indicia or a distinction marking. Reference 133 also includes a radius dimension for the top cover 112. Next, reference 136 refers to a top view of the controller compartment 115. As shown, the controller compartment 115 includes a recessed area for receiving the lighting device 109 into a light bulb socket.

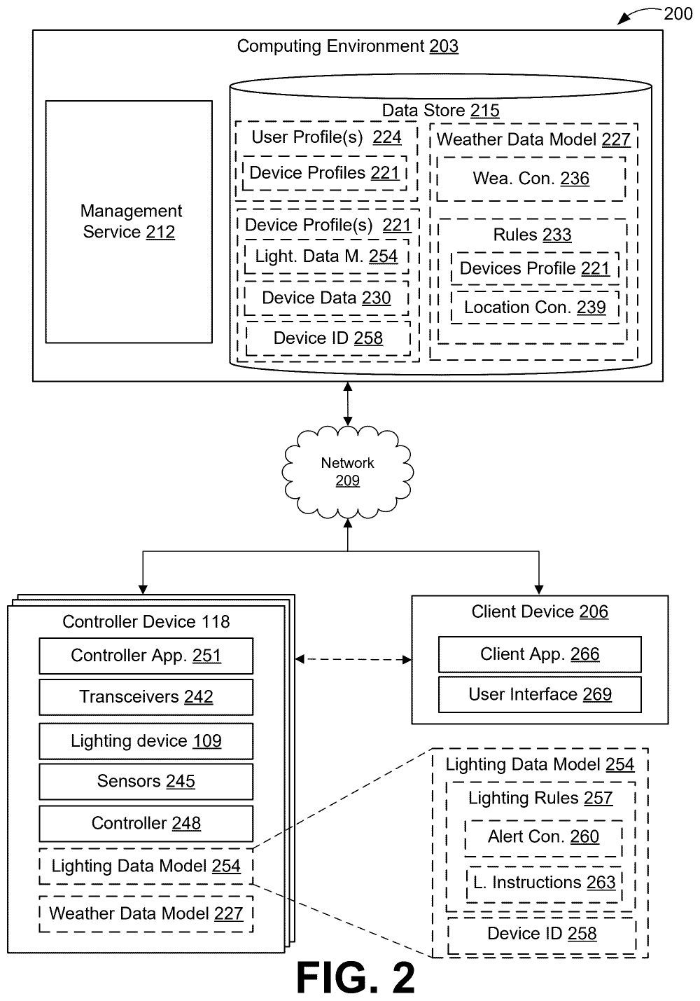

With reference to FIG. 2, shown is a network environment 200 according to various embodiments. The network environment 200 can include a computing environment 203, a client device 206, and a controller device 118, which can be in data communication with each other via a network 209.

The network 209 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 209 can also include a combination of two or more networks 209. Examples of networks 209 can include the Internet, intranets, extranets, virtual private networks (VPNs), and similar networks.

The computing environment 203 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 203 can employ a plurality of computing devices that can be arranged in one or more server banks or computer banks or other arrangements. Such computing devices can be located in a single installation or can be distributed among many different geographical locations. For example, the computing environment 203 can include a plurality of computing devices that together can include a hosted computing resource, a grid computing resource or any other distributed computing arrangement. In some cases, the computing environment 203 can correspond to an elastic computing resource where the allotted capacity of processing, network, storage, or other computing-related resources can vary over time.

Various applications or other functionality can be executed in the computing environment 203. The components executed on the computing environment 203 include a management service 212, and other applications, services, processes, systems, engines, or functionality not discussed in detail herein. The management service 212 can be executed to facilitate the generation of lighting and audible notifications by providing weather data models to the portable lighting apparatuses 103. The management service 212 can be in data communication with the portable lighting apparatus 103, the fixed stationary lighting devices 106, and/or other suitable networked lighting devices.

Also, various data is stored in a data store 215 that is accessible to the computing environment 203. The data store 215 can be representative of a plurality of data stores 215, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 215 is associated with the operation of the various applications or functional entities described below. This data can include devices profiles 221, user profiles 224, weather data models 227, and potentially other data.

The device profiles 221 can represent an account or a profile of a device that can receive weather data models 227 from the management service 212. The device profile 221 can include device data 230, lighting data models 254, device identifiers 258, and other suitable data. Some non-limiting examples of devices represented with a device profile 221 can include portable lighting apparatuses 103, lighting devices (e.g., networked light bulbs), a networked endpoint (e.g., a computing device), and other suitable devices. The device profile 221 can include device data 230 which can represent data associated with a particular device, such as device type, device location, Internet Protocol (IP) address, and other suitable data. The device identifier 258 can be a unique identifier for a lighting device, such as a portable lighting apparatus 103.

The user profile 224 can represent an account or profile for individual users or an organization. In some examples, the user operating the user profile 224 can be an administrative user. The user profile 224 can include one or more device profiles 221, personal data (e.g., user name, location), organization data (e.g., organization name, locations), and other suitable data.

The weather data models 227 can represent a collection of weather data for a particular location. The weather data model 227 can be associated with an interval of time. For example, the weather data models 227 can be transmitted to the controller device 118 of the portable lighting apparatus 103 every five seconds or another suitable time period. The weather data model 227 can include rules 233, weather conditions 236, and other suitable data. The weather conditions 236 can represent data for present weather conditions at a location, which are essentially associated with a period of time. Some non-limiting examples of weather conditions 236 can include temperature, wind, precipitation, National Weather Service alerts, lightning strikes, humidity, and other suitable weather conditions. These weather conditions 236 may be associated with a defined geographical area, such as a zip code, a county, a city, a state, a region, and other suitable geographic regions. In some examples, the weather conditions 236 can be valid for period of time, such as five second, thirty minutes, or other suitable time periods.

The rules 233 can represent data for triggering when and where the weather data models 227 are transmitted or broadcasted to devices, which have device profiles 221. The rules 233 can include the device profile 221, the location conditions 239, and other suitable data. In some examples, some of the data elements are omitted.

A non-limiting example of a rule 233 can include transmitting the weather data model 223 to a certain portable lighting apparatuses 103 on a periodic time period. Each device may be configured to receive the weather data model 223 on a user-specified time period. For example, the weather data model 227 can be sent every five seconds to a particular portable lighting apparatus 103 because the device profile 221 has these settings. In this example, the weather data model 227 includes present weather conditions (e.g., temperature, humidity, wind, precipitation, etc.). The devices (e.g., the portable lighting apparatus 103) can receive the weather data model 227 and determine whether lighting conditions are satisfied for illuminating one or more lighting devices 109.

In another example, a rule 233 can include if a high temperature threshold is reached for a location, then the weather data model 223 should be transmitted to the devices with the device profiles 221) located within a proximity to a region experiencing or soon to be experiencing the high temperatures. In another example, the National Weather Service alert is identified, a rule 233 can indicate that the weather data model 227 should be transmitted to the devices with the device profiles 221) located within a proximity to a region experiencing or soon to be experiencing the conditions associated with the National Weather Service alert.

The location condition 239 can represent location data or alert location conditions for the device profiles 221. The location condition 239 can also include a triggering condition or an alert location condition for transmitting the weather data model 227 to one or more devices (e.g., portable lighting apparatus 103) with associated with a location based at least in part on the device profile 221. Some non-limiting examples of the triggering conditions can include a high temperature threshold, a tornado warning event, a hurricane warning event, a lightning strike event, a severe thunderstorm event, a flooding event, and other suitable weather conditions.

The client device 206 is representative of a plurality of client devices that can be coupled to the network 209. The client device 206 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 206 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the client device 206 or can be connected to the client device 206 through a wired or wireless connection.

The controller device 118 can be representative of a computing device for operating the portable lighting apparatus 103. The controller device 118 can include one or more transceivers 242 (e.g., a communication device, such as a WiFi, Zigbee, Bluetooth, cellular, etc.), the lighting device 109, a sensor 245 (e.g., temperature sensor, wind temperature, humidity sensor, a water sensor), a controller 248 (e.g., a processor or processing unit), and other suitable components. The controller 248 can be in data communication with the components associated with the controller device 118. The sensor 245 can be used to measure weather related conditions (e.g., temperature, humidity, wind, moisture) in a proximate area to the portable lighting apparatus 103 and can be used to trigger lighting notifications.

Various applications or other functionality can be executed in the controller device 118. The components executed on the controller device 118 can include a controller application 251, and other applications, services, processes, systems, engines, or functionality not discussed in detail herein. The controller application 251 can be executed to facilitate the generation of lighting notifications on the portable lighting apparatus 103. Also, various data is stored in memory of the controller device 118. The data in the controller device 118 can include the weather data model 227, the lighting data model 254, and other suitable data.

The lighting data model 254 can represent a collection of data which can be used to determine whether to perform one or more lighting notifications by the portable lighting apparatus 103 and/or other lighting devices. The lighting data model 254 can include lighting rules 257 for indicating when and how lighting notifications are to be performed. The lighting data model 254 can include alert conditions 260, lighting instructions 263, and other suitable data. The alert conditions 260 can represent triggering weather conditions for a lighting instruction 263. The lighting instruction 263 can represent a lighting or an audible command for a lighting device 109 to execute based at least in part the alert condition 260 being satisfied.

Some non-limiting examples of alert conditions 260 can include a high temperature threshold for an area in proximity to the portable lighting apparatus 103, a lighting strike within a ten miles of the location of the portable lighting apparatus 103, a National Weather Service alert has been transmitted for the area, and other suitable weather related conditions. Some non-limiting examples of lighting instructions 263 can include illuminating a particular color, flashing at a particular rate, activating a group of lighting devices, and other suitable lighting instructions.

The client device 206 can be configured to execute various applications such as a client application 266 or other applications. The client application 266 can be in data communication with the controller device 118 of the portable lighting apparatus 103, lighting devices, the computing environment 203, and other suitable devices. The client application 266 can be executed to provide instructions and/or configure settings for data models (e.g., lighting data model 254, weather data model 227). These instructions and settings can be communicated to the controller device 118 and/or the computing environment 203.

The client application 266 also can be executed in a client device 206 to access network content served up by the computing environment 203 or other servers, thereby rendering a user interface 269 on the display. To this end, the client application 266 can include a browser, a dedicated application, or other executable, and the user interface 269 can include a network page, an application screen, or other user mechanism for obtaining user input. The client device 206 can be configured to execute applications beyond the client application 266 such as email applications, social networking applications, word processors, spreadsheets, or other applications.

Next, a general description of the operation of the various components of the network environment 200 is provided. To begin, a user can find a location in an outdoor setting to insert the rod member 130 of the portable lighting apparatus 103 into the ground of the desired location. The user can use a client application (e.g., a mobile application) to configure the portable lighting apparatus 103. For example, the user can enter a device identifier 258 to identify the portable lighting apparatus 103 for establishing a communication channel between the client device 206 and the controller device 118 of the portable lighting apparatus 103. On the client application 266, the user can select a network 209 (e.g., a WIFI network, a cellular network, a local area network, BLUETOOTH, a local area network, a personal area network, etc.) for the portable lighting apparatus 103 to use for data communication. For example, the client application 266 can transmit a network setting for the portable lighting apparatus 103 to use a WIFI network, in which a network identifier and a password are provided. In other example, the client application 266 can transmit a network setting for the portable lighting apparatus 103 receive data communication from the client device 206, in which the client device 206 is data communication via a wireless communication network (e.g., a BLUETOOTH network, a personal hotspot). As such, portable lighting apparatus 103 can receive weather data models 227 from the client device 206. The client application 266 can be used to select a location for the portable lighting apparatus 103. On the client application 266, the location can be selected on a map, entered as a mailing address, entered as longitudinal and latitudinal coordinates, and other suitable methods for entering location data.

Next, the client application 266 can be used to configure settings, such as a lighting data model 254. For example, the user can generate a first lighting rule 257 that includes an alert condition 260 and a lighting instruction 263. The alert condition 260 can specify a detection of a lightning strike within a five mile radius of the location of the portable lighting apparatus 103. The associated lighting instruction 263 can be specified as an instruction for the lighting device 109 to blink red at a rate period a time period (e.g., a rate of once per second).

As another example, a second lighting rule 257 can set the alert condition 260 to a lightning strike within ten miles from the location of the portable lighting apparatus 103. The associated lighting instruction 263 can be specified as an instruction for the lighting device 109 to turn on as the color orange in a constant state.

After these two rules have been transmitted to the controller device 118, the controller application 251 can receive weather data models 227 from the computing environment 203 at a periodic time interval (e.g., every 20 second). After receiving a weather data model 227, the controller application 251 can compare it to the lighting data model 254. If the alert conditions 260 are satisfied, then the controller application 251 execute the lighting instruction 263, which can activate the lighting device 109 according to the lighting instruction 263.

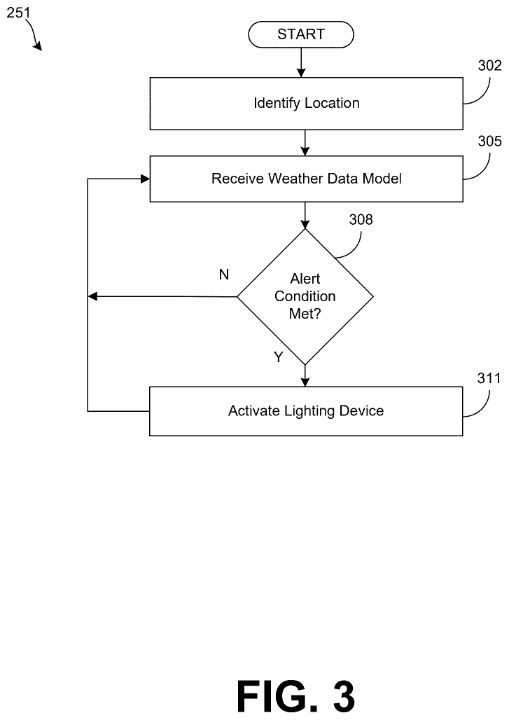

Referring next to FIG. 3, shown is a flowchart that provides one example of the operation of a portion of the controller application 251. The flowchart of FIG. 3 provides merely an example of the many different types of functional arrangements that can be employed to implement the operation of the depicted portion of the controller application 251. As an alternative, the flowchart of FIG. 3 can be viewed as depicting an example of elements of a method implemented within the network environment 200.

Beginning with block 302, the controller application 251 can identify a location of the portable lighting apparatus 103. In some examples, the controller application 251 can be in data communication with the client device 206. The controller application 251 can receive location data from the client device 206. The location data can include a longitudinal and latitudinal coordinate, a physical address, a location marked on a digital map, and other suitable data. In some examples, the controller application 251 can use a transceiver 242 to identify a location. For instance, the transceiver 242 can be used to triangulate a location based at least in part on network data received from other networking devices. In another instance, the transceiver 242 (e.g., cellular transceiver, GPS device) can be used to identify the location based at least on satellite data.

In block 305, the controller application 251 can receive a weather data model 227 from a remote computing device (e.g., computing environment 203), in which the weather data model 227 can include present weather conditions 236 for the location. In some examples, the weather data model 227 can be received on an interval time period. In some instances, the controller application 251 can establish a synchronous data channel with the remote computing device in order to retrieve the weather data model 227 on the interval time period.

In block 308, the controller application 251 determine whether the present weather conditions 236 satisfy an alert conditions 260 from the lighting data model 254. In some instances, the controller application 251 can determine whether local weather measurements from the sensor 245 satisfy the alert conditions 260.

In block 311, the controller application 251 can activate a lighting device 109 based at least in part on the present weather conditions 236 satisfying the alert condition and based at least in part on the lighting instruction 263 from the lighting data model 254. The lighting device 109 can be activated according to the lighting instruction 263.

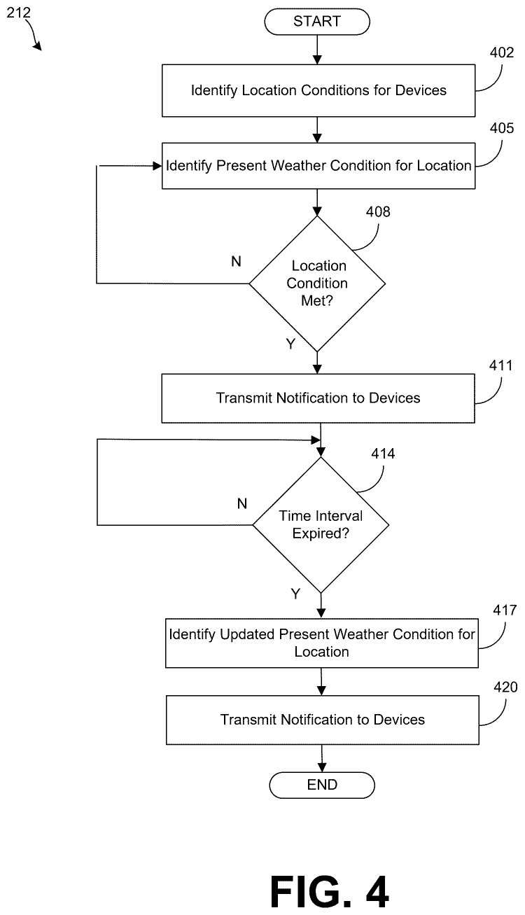

Referring next to FIG. 4, shown is a flowchart that provides one example of the operation of a portion of the management service 212. The flowchart of FIG. 4 provides merely an example of the many different types of functional arrangements that can be employed to implement the operation of the depicted portion of the management service 212. As an alternative, the flowchart of FIG. 4 can be viewed as depicting an example of elements of a method implemented within the network environment 200.

Beginning with block 402, the management service 212 can identify location conditions 239 or alert conditions 260 for a location of a device, such as a portable lighting apparatus 103, a stationary light devices 106, a lighting device 109, and other suitable devices. In some instances, the alert conditions 260 can be identified from the device profiles 221, the lighting data models 254, and other suitable data.

In block 405, the management service 212 can identify a present weather condition 236 for a location based at least in part on weather data model 227. In some examples, the weather data model 227 and/or the weather conditions 236 can be received from a remote computing device (e.g., of another computing provider). In other examples, the management service 212 can generate the weather data model 227 and/or the weather conditions 236 by collecting various data elements (e.g., models, weather measurements, etc.) from various data sources, such as other computing entities.

In block 408, the management service 212 can determine whether a location condition 239 has been met by the present weather conditions 236 from a weather data model 227. The location condition 239 can also include a triggering condition or an alert location condition for transmitting the weather data model 227 to one or more devices (e.g., portable lighting apparatus 103) with associated with a location based at least in part on the device profile 221. Some non-limiting examples of the triggering conditions can include a high temperature threshold, a tornado event, a hurricane event, a lightning strike event, a severe thunderstorm event, a flooding event, and other suitable weather conditions. For example, the present weather conditions 236 can be compared to one or more thresholds associated with the location conditions 239 to determine if the location conditions 239 are satisfied. In another example, the present weather conditions 236 can include a warning of a weather event (e.g., a severe thunderstorm event, a flooding event) that can trigger or satisfy a location condition 229. If the present weather conditions 236 satisfy the location conditions 239, then the management service 212 can proceed to block 411. If the present weather conditions 236 do not satisfy the location conditions 239, then the management service 212 can proceed to block 405.

In block 411, the management service 212 can transmit a first notification to devices (e.g., portable lighting apparatus 103, stationary light devices 106, a computing endpoint, an Internet of Thing devices, and other suitable devices) with device profiles 221 associated with the location condition 239. The device profiles 221 can include networking data (e.g., an IP address, an email address, a phone number, etc.) for transmitting the notification to the devices associated with the device profiles 221. The first notification can include a weather data model 227.

In block 414, the management service 212 can determine whether a time interval has expired. A timer can start upon transmitting the first notification to the devices in block 411. The time interval can represent a predefined an amount of time to elapse. If the time interval has expired, then the management service 212 can proceed to block 417. If the time interval has not expired, then the management service 212 can return to block 414.

In block 417, the management service 212 can identify an updated present weather condition for a location based at least in part on weather data model 227. In some examples, the weather data model 227 and/or the weather conditions 236 can be received from a remote computing device (e.g., of another computing provider). In other examples, the management service 212 can generate the weather data model 227 and/or the weather conditions 236 by collecting various data elements (e.g., models, weather measurements, etc.) from various data sources, such as other computing entities. The updated present weather condition can be associated with a subsequent time period after an initial time period for the present weather condition in block 405.

In block 420, the management service 212 can transmit a second notification to devices (e.g., portable lighting apparatus 103, stationary light devices 106, a computing endpoint, an Internet of Thing devices, and other suitable devices) with device profiles 221 associated with the location condition 239. The management service 212 can transmit the second notification based at least in part on the updated present weather condition meeting a location condition. The second notification can include a second weather data model 227. Then, the management service 212 can proceed to the end.

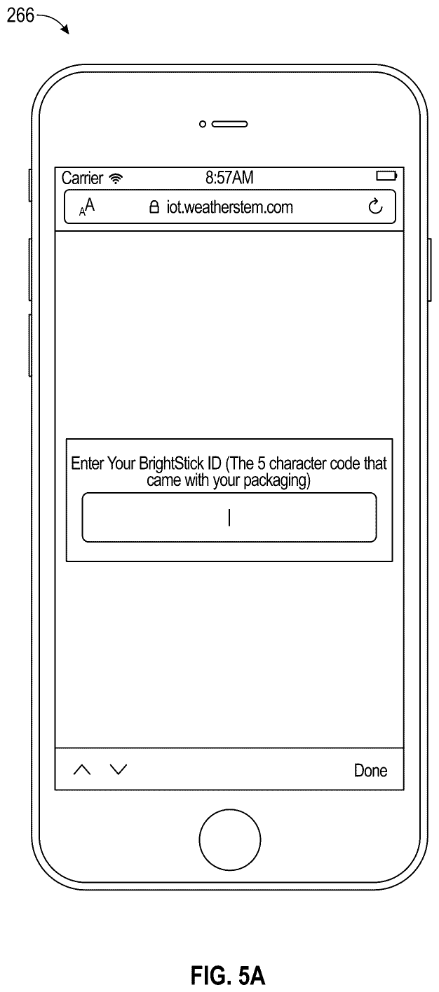

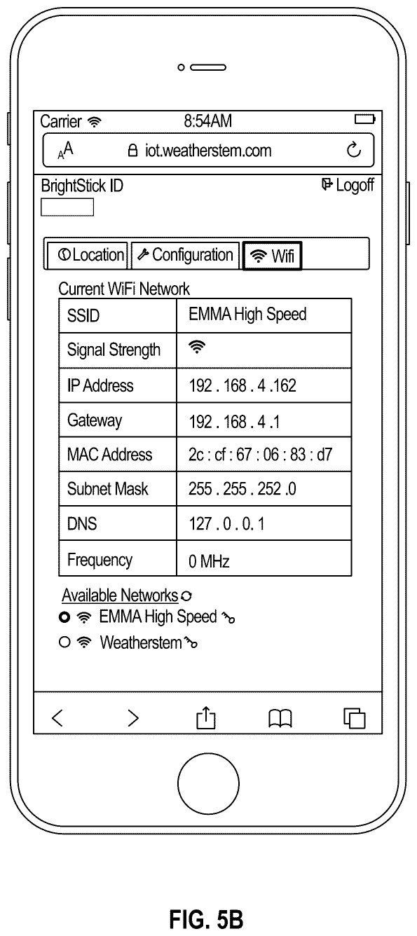

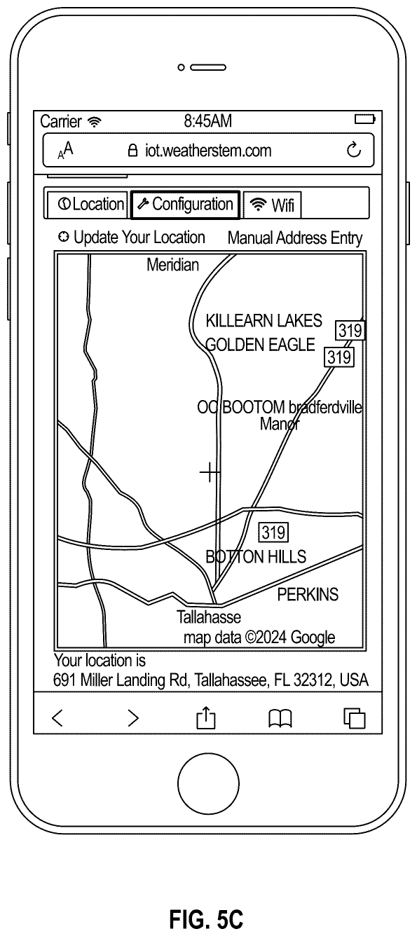

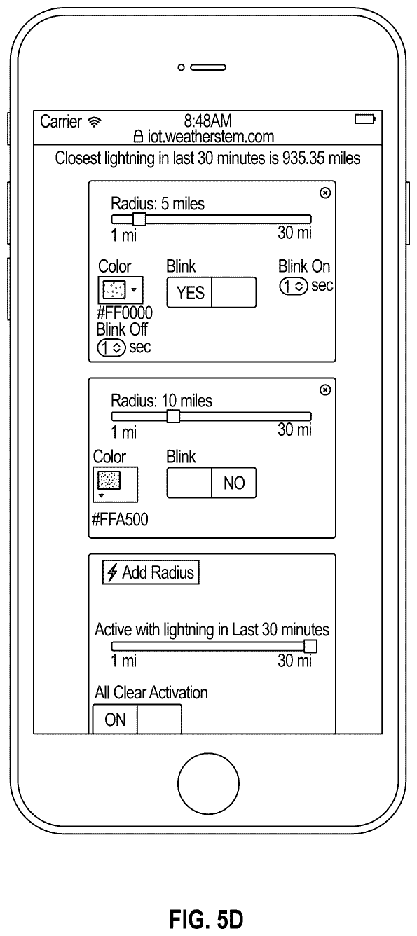

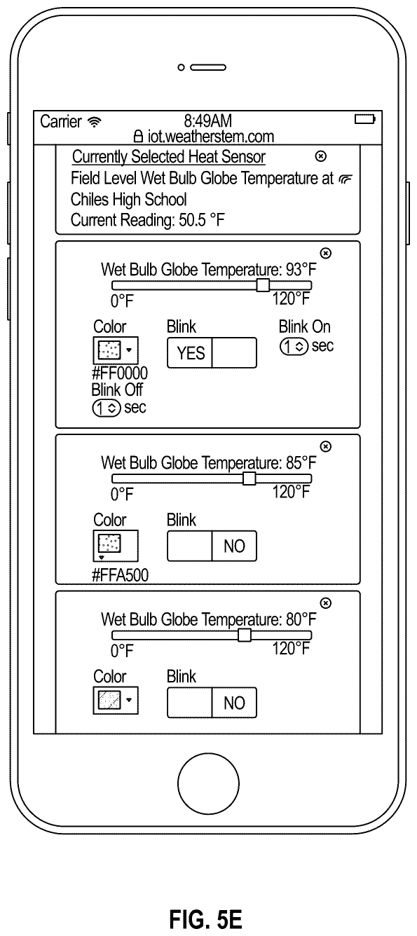

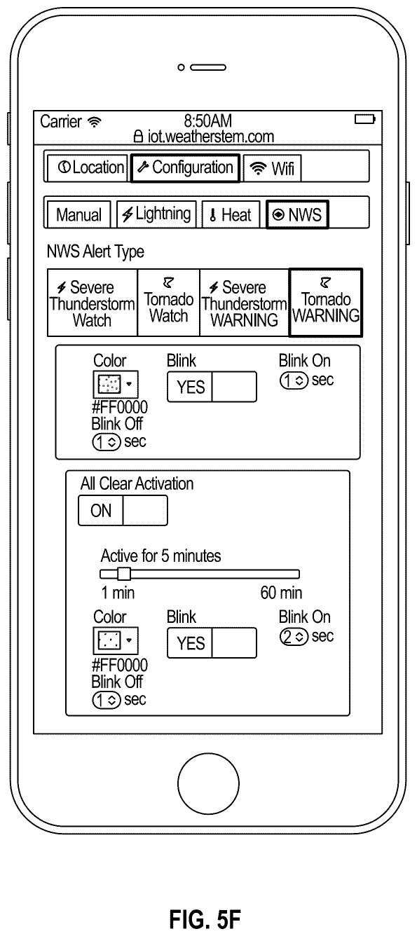

Moving on to FIGS. 5A-5F, shown are various examples of user interfaces 269 displayed on the client device 206. The user interfaces 269 are displayed for rendering data related to the portable lighting apparatus 103 and for configurating the lighting data model 254. The client application 266 can generate the user interfaces 269. FIG. 5A illustrates a first user interface 269 for receiving a device identifier 258 associated with the portable lighting apparatus 103. By entering the device identifier 258, the client application 266 can begin a registration or a configuration process. The client application 266 can be in data communication with the management service 212. For example, the client application 266 can transmit the entered device identifier 258 to the management service 212. In response, the management service 212 can transmit data associated with the device identifier 258, which can be associated with a particular type or model of a portable lighting apparatus 103.

FIG. 5B illustrates a second user interface 269 for configuring wireless communication for the portable lighting apparatus 103. For example, the second user interface 269 can receive an entry of settings for a wireless communication network (e.g., a WIFI protocol, BLUETOOTH protocol, Zigbee protocol, etc.). The client application 266 can transmit the settings and/or selection of the wireless communication network to the portable lighting apparatus 103. As a result, the portable lighting apparatus 103 will be configured for data communication with the wireless network via a transceiver 242.

As shown in FIG. 5B, the second user interface 269 can receive a selection of an available wireless network. Additionally, the second user interface 269 displays data associated with a present wireless network, such as a signal strength, an Internet Protocol address, and other suitable data. In some examples, the client application 266 can transmit an instruction for an encryption scheme for the portable lighting apparatus 103 when transmitting and receiving data on the wireless network. In some examples, the encryption scheme can include a symmetric key for both encryption and decryption. In other examples, the encryption scheme can include an asymmetric key pair of a public and private key pair.

FIG. 5C illustrates a third user interface 269 for entering a location of the portable lighting apparatus 103 on a geographic map. The client application 266 can be configured to receive a manual entry of an address location, location coordinates, location data from a location detection device (e.g., a global positioning system, transceiver for a beacon location scheme, etc.) of the client device 206. In other examples, the geographic map can be dynamically moved or altered for a user selection of a location on the geographic map.

FIG. 5D illustrates a fourth user interface 269 can be configured for setting and specifying alert conditions 260, the lighting instructions 263, and other apparatus settings for one or more portable lighting apparatuses 103. For example, the fourth user interface 269 illustrates settings for a detection of a weather event (e.g., a lightning strike) with a predefined distance of the portable lighting apparatus 103 and a lighting instruction 263 (e.g., activate the lighting device 109 to blink for a predefined period of time and blink a particular lighting color) for the detection of the weather event. The fourth user interface 269 illustrates a first alert condition 260 for a five mile radius and a first lighting instruction 263 if the first alert condition 260 is detected. Then, a second alert condition 260 for a ten mile radius and a second lighting instruction if the second alert condition 260 is detected. In some examples, the fourth user interface 269 can be used for configuring the rules 233 (e.g., device profiles 221, location conditions 239) for a location.

FIG. 5E illustrates a fifth user interface 269 that includes other examples of alert conditions 260 and the associated lighting instructions 263. For example, the alert conditions 260 provide setting alerts related to one or more sensors 245 (e.g., a heat sensor setting is shown in FIG. 5E). Different lighting instructions 263 are activated based at least in part on which alert condition 260 is detected.

FIG. 5F illustrates a sixth user interface 269 configured for configuring various settings (e.g., alert conditions 260, location conditions 239). For example, the sixth user interface 269 allows for the user to select an agency weather alert type (e.g., Severe Thunderstorm, a Tornado Watch, etc.) as an alert condition 260 and the lighting instructions 263 for each alert condition 260. For instance, if the National Weather Service puts out a Tornado Watch warning, this warning will satisfy an alert condition 260. Then, the lighting instruction 263 for the alert condition is activated for the portable lighting apparatus 103.

In some examples, the portable lighting apparatus 103 can include sensor 245 that detects water or flooding conditions. For example, the portable lighting apparatus 103 can be positioned along an edge of a river. If the river floods, the sensor 245 can detect the water as an alert condition and can active a lighting instruction 263. The lightning instruction 263 can include activating a speaker to generate an audible alert and activating the lighting device 109 to blink or illuminate.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 3 and 4 show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts of FIGS. 3 and 4 show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts of FIGS. 3 and 4 can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 203.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A portable lighting apparatus, comprising:
a lighting device;
a controller device comprising a processor and memory, the controller device being configured to programmatically control the lighting device;
a battery that is electrically coupled to the lighting device and the computing device;
a rod member that is attached to the lighting device, the controller device and the battery;
machine readable instructions stored in the memory that, when executed by the processor, cause the controller device to at least:
identify a location of the portable lighting apparatus;
receive a present weather condition for the location from a remote computing device;
determine the present weather condition satisfies an alert condition from a lighting data model for the location; and
activate the lighting device based at least in part on the present weather condition satisfying the alert condition, the lighting device being activated based at least in part on a lighting instruction being associated with the alert condition from the lighting data model.

2. The portable lighting apparatus of claim 1, wherein the controller device comprise a wireless transceiver, the wireless transceiver being used for data communication between the computing device and the remote computing device.

3. The portable lighting apparatus of claim 1, wherein the lighting instruction specifies activating the lighting device to illuminate a color light for the alert condition.

4. The portable lighting apparatus of claim 1, wherein the lighting instruction specifies activating the lighting device to illuminate at a light intensity level for the alert condition.

5. The portable lighting apparatus of claim 1, wherein the lighting instruction specifies activating the lighting device to illuminate at a light intensity level for the alert condition.

6. The portable lighting apparatus of claim 1, wherein the machine-readable instructions further cause the controller device to at least:
receive the lighting data model for the location from a client device; and
store the lighting data model for the location in the memory.

7. The portable lighting apparatus of claim 1, wherein the machine-readable instructions further cause the controller device to at least:
transmit, via a wireless transceiver of the controller device, the light instruction to a plurality of proximity lighting devices based at least in part on the present weather condition satisfying the alert condition.

8. The portable lighting apparatus of claim 1, further comprising a speaker, and wherein the machine-readable instructions further cause the controller device to at least:
activate the speaker to generate an audible alert based at least in part on the present weather condition satisfying the alert condition, the speaker being activated based at least in part on a speaker instruction being associated with the alert condition from the lighting data model.

9. A method, comprising:
identifying, by a portable lighting apparatus that comprises a controller device and a lighting device, a location of the portable lighting apparatus;
receiving, by the portable lighting apparatus, a present weather condition for the location from a remote computing device;
determining, by the portable lighting apparatus, the present weather condition satisfies an alert condition from a lighting data model for the location; and
activating, by the portable lighting apparatus, the lighting device based at least in part on the present weather condition satisfying the alert condition, the lighting device being activated based at least in part on a lighting instruction being associated with the alert condition from the lighting data model.

10. The method of claim 9, wherein the controller device comprise a wireless transceiver, the wireless transceiver being used for data communication between the computing device and the remote computing device.

11. The method of claim 9, wherein the lighting instruction specifies activating the lighting device to illuminate a color light for the alert condition.

12. The method of claim 8, wherein the lighting instruction specifies activating the lighting device to illuminate at a light intensity level for the alert condition.

13. The method of claim 9, wherein the lighting instruction specifies activating the lighting device to illuminate at a light intensity level for the alert condition.

14. The method of claim 9, further comprising:
receiving, by the controller device, the lighting data model for the location from a client device; and
storing, by the controller device, the lighting data model for the location in the memory.

15. The method of claim 9, further comprising:
transmitting, by a wireless transceiver of the controller device, the light instruction to a plurality of proximity lighting devices based at least in part on the present weather condition satisfying the alert condition.

16. The method of claim 9, wherein the controller device comprises a speaker, and further comprising:
activating, by the controller device, the speaker to generate an audible alert based at least in part on the present weather condition satisfying the alert condition, the speaker being activated based at least in part on a speaker instruction being associated with the alert condition from the lighting data model.

17. A system, comprising:
a computing device comprising a processor and a memory; and
machine-readable instructions stored in the memory that, when executed by the processor, cause the computing device to at least:
identify a location condition for a location of a lighting apparatus;
identify a present weather condition for the location;
determine the present weather condition satisfies the location condition; and
transmit a notification to the lighting apparatus based at least in part on the present weather condition satisfying the local condition.

18. The system of claim 17, wherein the notification is a first notification, the location condition is a first location condition, and the machine-readable instructions stored in the memory that, when executed by the processor, cause the computing device to at least:
determine a time interval has expired;
identify an updated present weather condition for the location based at least in part on the time interval expiring; and
transmit a second notification to the lighting apparatus based at least in part on the updated present weather condition satisfying a second location condition.

19. The system of claim 17, wherein the notification comprises a weather data model.

20. The system of claim 19, wherein the weather data model comprises a weather condition for the location for a time period.
